(19) United States
(12) Patent Application Publication
(10) Pub. No.: US 2012/0284069 A1
(43) Pub. Date: Nov. 8, 2012

(54) METHOD FOR OPTIMIZING PARAMETERS IN A RECOMMENDATION SYSTEM

(75) Inventor: Thomas KEMP, Esslingen (DE)

(73) Assignee: Sony Corporation, Tokyo (JP)

(21) Appl. No.: 13/417,891

(22) Filed: Mar. 12, 2012

(30) Foreign Application Priority Data
May 4, 2011 (EP) 11003663.9

(51) Int. Cl. G06Q 10/00

(52) U.S. Cl. 705/7.11

(57) ABSTRACT

Method for optimizing a current set of parameters in a recommendation system during runtime, including a determining step for determining a first set of parameters depending on the current set of parameters and a second set of parameters depending on the first set of parameters and on user actions with respect to previous recommendations; a testing step for comparing, during runtime and with respect to a predetermined target function, an output of the recommendation system using the first set of parameters against an output of the recommendation system using the second set of parameters; and a selecting step for selecting the first set of parameters or second set of parameters as the current set of parameters depending on a comparison result of the testing step.

An embodiment of the invention relates to a method for optimizing a set of parameters in a recommendation system during runtime. Further embodiments of the invention relate to a recommendation system and to a purchasing system including the recommendation system, wherein the parameters are optimized during runtime.

### BACKGROUND

With the growing number of items available, e.g. selectable, downloadable or purchasable, from platforms accessible e.g. via internet, recommendation systems for recommending items to potential customers have become crucial for the success of these platforms. These recommendation systems must be adapted to changes relevant to the market, such as changes of the items to be recommended, but also changes in the customer behavior.

It is an object of the invention to provide a method for adapting a recommendation system in accordance with the users' needs and desires. It is further an object to provide a recommendation system adaptable to changing conditions.

These objects are solved by a method and system according to the independent claims.

Further details of the invention will become apparent from the consideration of the drawings and the ensuing description.

### BRIEF DESCRIPTION OF THE SEVERAL VIEWS OF THE DRAWINGS

The accompanying drawings are included to provide a further understanding of embodiments and are incorporated in and constitute a part of this specification. The drawings illustrate embodiments and together with the description serve to explain principles of embodiments. The embodiments and many of the intended advantages of embodiments will be readily appreciated as they become better understood by reference of the following detailed description. The elements of the drawings are not necessarily to scale relative to each other. Like reference numerals designate corresponding similar parts.

FIG. 1 illustrates an embodiment of a method for optimizing a recommendation system during runtime.

FIG. 2 illustrates a further embodiment of a method for optimizing a recommendation system during runtime.

FIG. 3a illustrates an intermixing of recommendation items from two different recommendation lists generated by the recommendation system using two different sets of parameters tested against each other.

FIG. 3b illustrates an intermixing of recommendation items from two different recommendation lists, the first one being generated using a new set of parameters and the second one being generated by using a previous set of parameters.

FIG. 4 illustrates an embodiment of a recommendation system.

FIG. 5 illustrates an embodiment of a purchasing system including a recommendation system.

### DETAILED DESCRIPTION

In the following, embodiments of the invention are described. It is important to note that all described embodiments may be combined in any way, i.e. there is no limitation that certain described embodiments may not be combined with others. Further, it should be noted that the same references throughout the Figures denotes same or similar elements.

It is further to be understood that other embodiments may be utilized and structural or logical changes may be made without departing from the scope of the invention. The following detailed description, therefore, is not to be taken in a liming sense, and the scope of the present invention is defined by the appended claims.

It is to be understood that the features of the various embodiments described herein may be combined with each other, unless specifically noted otherwise.

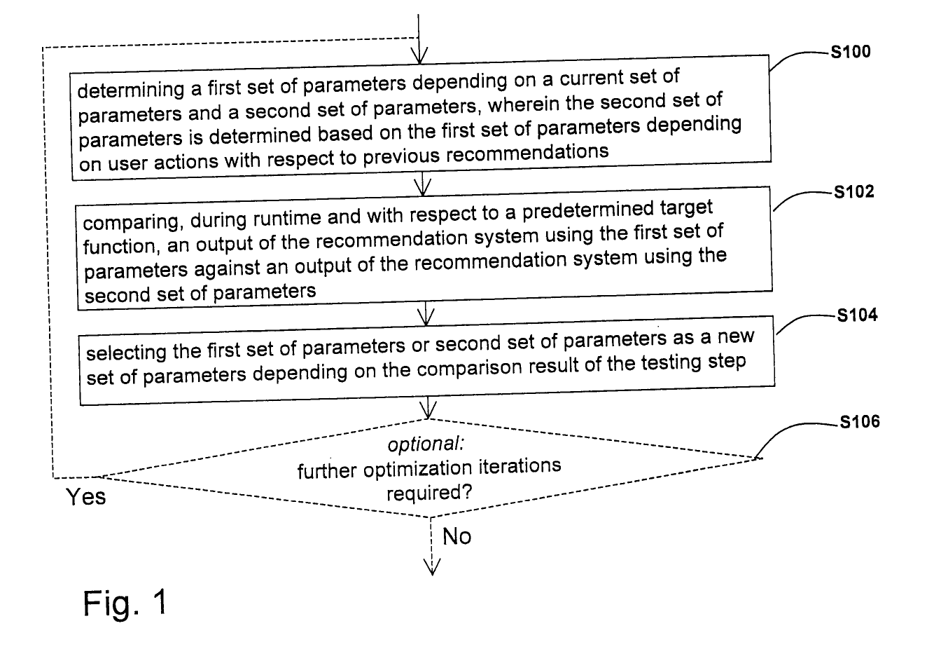

In FIG. 1, an embodiment of a method for optimizing a current set of parameters in a recommendation system during runtime is illustrated. The method includes a determining step S100 for determining a first set of parameters depending on a current set of parameters and a second set of parameters depending on the first set of parameters and on user actions with respect to previous recommendations.

The method further includes a testing step S102 for comparing, during runtime and with respect to a predetermined target function, an output of the recommendation system using the first set of parameters against an output of the recommendation system using the second set of parameters.

Further, the method includes a selecting step S104 for selecting the first set of parameters or second set of parameters as the current set of parameters depending on a comparison result of the testing step S102.

Within the method, at S106, it may be optionally checked whether further optimization iterations are required. If so, determining step S100, testing S102 and selecting step S104 are repeated, after having concluded selecting step S104 of a previous iteration. This is illustrated by the dashed arrow leading back to determining step S100.

The recommendation system may be run, for example, on one or multiple microprocessors for recommending items to users, e.g. in a platform accessible for the users via an electronic network, such as the internet.

The platform may be a download platform, a vending platform, a link suggestion platform or any other kind of recommendation platform.

The items recommended to the users may be, for example, any real world objects that may be purchased by the users via the platform. Thus, the platform may correspond to a web store or a web market place, allowing concluding purchasing contracts between participating customers and vendors.

Further, the recommended items may be digitally encoded and may be downloadable for free or after a purchase of the item. For example, the items may include software, multimedia data such as video, audio, still image data or text data or any other digital items that may be consumed by the users. The items may also include links to other sites within the network, contact data for contacting service providers or other kinds of references. Typically, a multitude of items may be available for the users who have to select items according to their personal needs and likings.

For this purpose, the recommendation system may generate recommendations providing a certain user, for example, with links to items or other identification data of items of potential interest to the user. A recommendation may include a single item or a list of items. The list of items may be organized according to a ranking determined by the recommendation system, e.g. by sorting the items according to an estimated likelihood that the user will select or purchase a respective item.

The recommendation system may be, as will be discussed below, coupled with a purchasing system enabling the users to perform purchasing transactions, e.g. to buy the items recommended by the recommendation system.

The recommendation system may comprise one or more algorithms for recommending items to the users. These algorithms may depend on multiple parameters which are assumed to be included in the sets of parameters.

The parameters may serve multiple purposes. For example, if one of the algorithms is a collaborative filtering algorithm determining suggestions based on likes and dislikes or purchases of a whole population, one of the parameters can reflect, for example, a number of similar or close items to be considered when generating a further recommendation list for a certain user. In a recommendation system for recommending multimedia data such as movies, a further parameter may define a relative weight of a “genre” field of the movie with respect to a weight of an “actors” field, and so on.

From these examples, it becomes clear that some of the parameters may be common e.g. for plural algorithms in the recommendation system, while other parameters may be tied to specific algorithms or even to a certain user. Thus, the parameters may be user-specific.

Since the behavior of the recommendation system depends on the parameters, the functioning of the recommendation system may be optimized by adjusting the parameters. This “tuning” or parameter selection may be carried out for achieving optimization with respect to several aspects.

For example, it may be an object to select the parameters such that the recommendations are successful, e.g. have a high probability of inciting a user to select, buy or download the recommended item(s). To achieve this goal, the parameters may be selected e.g. in accordance with a personal profile of respective users, describing their personal likings. Thus, the parameters may be selected and optimized with respect to each of the users separately.

Other goals when optimizing a set of parameters may be a quick output or an efficient calculation of the recommendations, minimizing the resources needed. This kind of optimization does not have to take the personal user profile into account, but may be performed by selecting parameters applicable for generating recommendations for each of the users.

The goal which is to be achieved by the tuning or parameter selection may be described by means of the target function. For example, if a success of the recommendations is to be optimized, the target function may measure, with respect to a given set of parameters, a relative frequency with which the recommendations have led to a selection event, e.g. a purchase of the user. The target function may thus depend on a proportion of successful recommendations, e.g. a number of selections and/or purchases with respect to all recommendations output by the recommendation system. Further, also a selection of an item for gathering more information related to the item may be regarded as an indicator of success within the target function.

It is further possible to measure multiple results of the recommendations, e.g. in a target vector including a plurality of components. Thus, the parameter selection may be performed with respect to multiple goals to be achieved, represented by the target vector.

Since the observed behavior of the users provides valuable feedback with respect to a success of the recommendations, the tuning of the parameters may be performed with respect to this feedback. Therefore, the behavior of the users during runtime of the system may be continuously observed and used as a basis for the optimization. This allows tuning the recommendation system based on historical data gained from the observed user behavior in an already deployed recommendation system. Thus, the parameters of an already deployed recommendation system may be repeatedly and continuously optimized with respect to the observed user behavior.

In this respect, it should, however, be noted that the recommendations themselves may alter the behavior of the users, and that hence, simulations from the past cannot necessarily predict the future well. Further, a lot of information that would be helpful for optimizing set of parameters is missing in conventional download and purchasing platforms, which generally do not require a complete feedback with respect to every single recommendation. For example, the fact that the user did not select or purchase an item does not necessarily imply that the user does not like the item. Contrasting to this, it is also possible that the item was only number 2 on his “wish-list”, or that the user did not even notice the recommendation. Thus, information upon what the user dislikes may not be gathered easily.

Further, if the parameters of the recommendation system are optimized based on historical data, the recommendation system is optimized towards recommending things that the user has selected or bought in the past. These items, however, may be assumed to be no longer of interest to the user. Further, a recommendation system optimized with respect to historical data will not be able to recommend new or non-obvious things, for example as serendipity recommendations.

Thus, parameter optimization may regard further aspects in addition to the historical data. This, however, may also lead to parameter settings which may be less successful than expected. It may include a high risk to set up the recommendation system with a new set of parameters when no indication of a probable success of the new set of parameters may be drawn from the historical data. For example, it may be that the newly optimized system performs poorly, e.g. with respect to the target function.

Therefore, it is necessary to early and realistically assess the effect of proposed parameter changes, and further to be able to quickly amend parameter sets which have been found to be unsuccessful. These abilities would allow minimizing a risk if a new parameter set is put into practice.

In view of these goals, the embodiment illustrated in FIG. 1 includes determining step S100 for determining a first set of parameters and a second set of parameters. The first set of parameters may depend on the set of parameters currently used in the deployed recommendation system. For example, the first set of parameters may entirely correspond to the current set of parameters.

The second set of parameters may be a different set of parameters. It may, for example, depend on the first set of parameters and on user actions with respect to previous recommendations, or may be derived from the first set of parameters, as will be discussed in the following. However, the second set of parameters may also be amended in view of other aspects, such as aspects of recent collaborative filtering results, surprise or serendipity aspects and/or aspects of newly included items such as newly presented products, upcoming events or the like. Further, the second set of parameters may be determined based on a suggestion of an expert.

During testing step S102, the behavior of the recommendation system, on the one hand based on the first set of parameters and on the other hand based on the second set of parameters, is compared during runtime with respect to the target function. For example, an output of the recommendation system using the first set of parameters is observed, evaluated by the target function and compared to an output of the recommendation system using the second set of parameters, also evaluated by the target function.

To achieve this goal, incoming user requests to the recommendation system may be randomly split into two parts according a predefined probability distribution. The first part may be served by the recommendation system using the first set of parameters, while the second part may be served by the recommendation system using the second set of parameters.

The results of the recommendations may be evaluated with respect to the target function. For example, a relative frequency of recommendations leading to a selection or purchasing transaction may be measured. This allows a realistic assessment of the performance of either of the parameter sets and a statistical comparison with respect to the target function.

The probability distribution according to which the incoming user requests are split may be adapted according to an estimated risk included in the respective parameter sets with respect to their performance. For example, if the second set of parameters includes a high risk, since it is very different from the current set of parameters or from other known sets of parameters, the probability distribution may firstly assign only a small probability that users are served by the second set of parameters. Thus, new parameter sets may be tested and assessed with respect to the target function during runtime without effecting an overall performance or success of the recommendation system.

After a certain period of runtime during which testing step S102 has been carried out, a decision may be taken in selecting step S104 by selecting either the first set of parameters or the second set of parameters as the current set of parameters, depending on the comparison result of testing step S102. For example, the set of parameters with better output with respect to the target function may be selected. The recommendation system may then be run using the selected set of parameters as the current set of parameters.

During runtime, a further need requiring further optimization iterations may arise, as illustrated at 5106. In this case, the embodiment of the method as described in the above may be repeated, i.e. determining step S100, testing step S102 and selecting step S104, allowing to further adapt the recommendation system, and in particular the parameters used within the recommendation system, to any changes that might have occurred within the system, e.g. an amended user behavior or amended items accessible via the platform. Thus, these changes may be automatically compensated by the recommendation system, and the recommendation system may be dynamically adapted and optimized.

It may thus be assumed that the parameters will be near optimal with respect to the current state within the platform, e.g. with respect to the current user behavior and the properties of the current set of items. Further, with the embodiment of the method as discussed, the optimization may be performed without the need of costly and time consuming experiments.

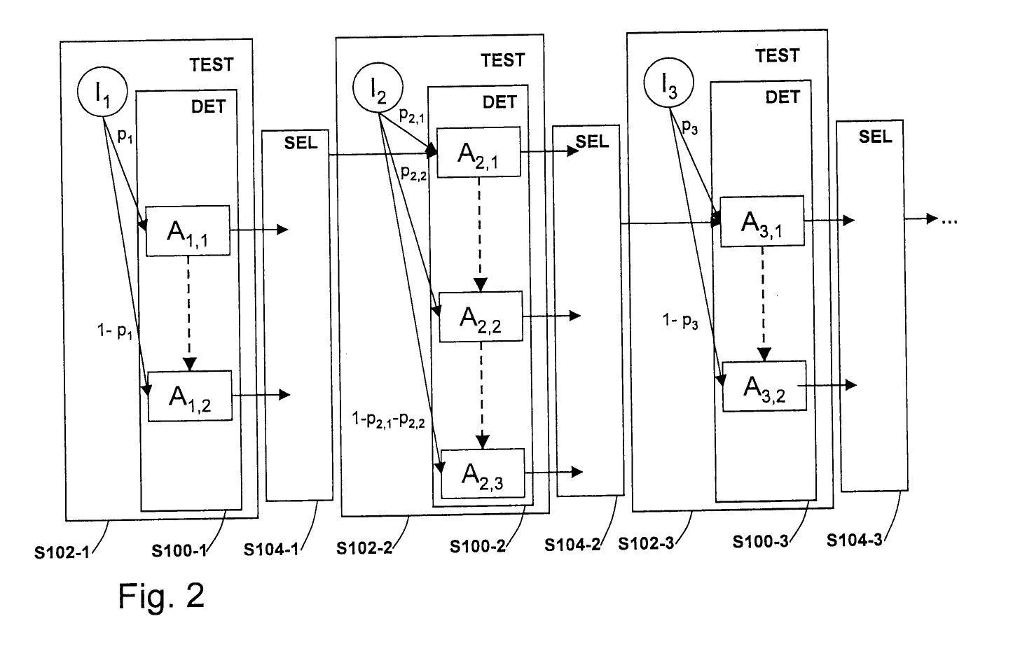

In FIG. 2, a further embodiment of the method is illustrated as evolving over time in several iterations. Determining step S100, testing step S102 and selecting step S104 are marked by frames labeled “DET”, “TEST” and “SEL”, respectively.

In the left most determination step S100-1 in FIG. 2, the first set of parameters is represented by A_{1, 1}. In determination step S100-1, a second set of parameters A_{1, 2} is derived from first set of parameters A_{1, 1}, as indicated by the dashed arrow.

Parameter sets A_{1.1} and A_{1, 2} are then tested against each other in testing step S102-1. For this purpose, incoming user requests I₁ are randomly split to be served by the recommendation system using A_{1.1} with a probability p₁ or by the recommendation system using A_{1, 2} with a probability 1-p₁.

The outcome of the corresponding recommendations is then provided to selection step S104-1, where according to a comparison with respect to the target function the first or second set of parameters is selected as a new set of parameters for the following iteration. The selected set of parameters A_{2, 1} is then provided as the first set of parameters to determining step S100-2.

Within determining step S100-2, parameter sets A_{2, 2} and A_{2, 3} are derived from A_{2, 1}, as indicated by the dashed arrows.

In a further testing step S102-2, the parameter sets are then selected randomly as a basis for serving the incoming user requests I₂ with a respective probability p_{2, 1}, p_{2, 2} or 1-p_{2, 1}−p_{2, 2}. Parameter sets A_{2, 1}, A_{2, 2} and A_{2, 3} are thus randomly evaluated.

At further selection step S104-2, the most promising or best performing parameter set is selected as the first parameter step A_{3, 1}, which parameter set is then provided to determining step S100-3 of the next iteration.

These steps and iterations may thus be continuously repeated, e.g. whenever the need for an adaption of the parameter set of the recommendation system arises, e.g. whenever the success of the recommendations based on a current parameter set decreases. Thus, the recommendation system is continuously optimized and adapted to evolving circumstances within the platform.

As illustrated in determining steps S100-1, S100-2 and S100-3, the further parameter sets to be tested may be derived from the first parameter set A_{1, 1}, A_{2, 1} and A_{3, 1}, respectively. The second set of parameters may be determined depending on the first parameters e.g. by modifying at least one of the parameters of this first set of parameters.

In an embodiment, the at least one of the parameters may be modified based on a random variation of the at least one of the parameters.

For example, a free parameter of the first set of parameters may be picked randomly, or may be determined in successive iterations according to a predetermined order. This parameter may then be modified, e.g. by a reasonably small amount. The second set of parameters may then include the modified parameter, while all other parameters correspond to those of the first of parameters. As discussed in the above, both sets of parameters may then be tested in the consecutive testing step S102-1, and the better performing set of parameters may be selected in the selecting step S104-1 as new set of parameters A_{2, 1} of the next iteration.

For assuring that the modified parameter does not lead to a completely different behavior of the recommendation system, a maximum distance for the modification may be defined.

In a further embodiment, a gradient of the target function may be determined with respect to the first set of parameters A_{1, 2} in determining step S100-1. The second set of parameters A_{1, 2} may then be determined based on the gradient, e.g. by using a parameter optimization method e.g. following a steepest ascent indicated by the gradient.

For determining the gradient of the target function with respect to all of the freely modifiable parameters of the recommendation system, all free parameters can be varied and the target function may be determined or estimated with respect to the varied parameters. The gradient may be determined e.g. by determining the slope of the target function with respect to the parameter change.

Once the gradient is determined, the second set of parameters A_{1, 2} may be determined by adding the gradient multiplied by a predetermined or adaptable learning rate to the first set of parameters A_{1, 1}, thereby obtaining the second set of parameters A_{1, 2}. Further sets of parameters, e.g. a third or fourth set of parameters, may be determined by further varying the learning rate, and thus adapting a range of the modifications allowed during optimization.

These sets of parameters may then be tested as described in the above, and the best performing of the sets can be selected as the new parameter set for the recommendation system or as a new first set of parameters for the next iteration.

In a further embodiment, a gradient may be estimated by determining intermediate sets of parameters based on the first set of parameters by modifying one-by-one the parameters of the first set of parameters, and by evaluating, during runtime and with respect to the target function, the output of the recommendation system using the first set of parameters and the output of the recommendation system using the intermediate sets of parameters, respectively. Components of the gradient with respect to the free parameters may then be estimated by subtracting the value of the target function observed with respect to recommendations achieved by the respective intermediate set of parameters from the value of the target function achieved for recommendations based on the first set of parameters. This difference may then be divided by a distance between the respective intermediate set of parameters and the first set of parameters.

In other words, the gradients may be derived by modifying one parameter at a time and evaluating the resulting set of parameters in a testing step corresponding to S102-1. The resulting value of the target function may be directly measured from the user behavior with respect to the recommendations, e.g. from the success of the recommendations issued based on the modified parameter set. This process may be repeated for each of the free parameters within the first parameter set. The resulting gradient with respect to all free parameters may then be used as discussed in the above.

In a further embodiment, determining step S100, testing step S102 and selecting step S104 may be carried out after a successful recommendation during runtime of the recommendation system. In determining step S100, the current set of parameters may be used as the first set of parameters. A further set of parameters may be determined based on the first set of parameters by varying at least one of the (free) parameters, or may be all of the parameters, of the first set, such that in a recommendation list output by the recommendation system based on the further set of parameters, a rank of the successful recommendation is improved compared to a further rank of the successful recommendation in a further recommendation list output by the recommendation system based on the first of parameters. The second set of parameters may then be determined based on a fraction of a difference between the further set and the first set.

In other words, after a successful recommendation during runtime, a further step of optimization is induced. To obtain a second set of parameters for the optimization, the current set of parameters is changed, e.g. by a small amount, in such a way that the recommendation system will issue the successful recommendation in the future with a higher likelihood than before. This is achieved by determining a further set of parameters such that a rank of the successful recommendation is improved. The recommendation system is therefore permanently updated while the system is running, albeit by very small steps.

The “movement” of the parameter set within a parameter space may thus remind of a small particle that is moved by a small, random impact, leading to a kind of Brownian motion.

Thus, for determining the further set of parameters, a rank of the successful recommendation may be analyzed in the current recommendation list. If the rank was best, i.e. one, the parameters do not have to be optimized. If the rank, however, was worse, e.g. higher than one, a randomly selected free parameter of the system may be modified by a small amount, and a new recommendation list may be calculated based on the resulting further set of parameters. If the rank improves, it is recorded by what amount (how many ranks, relative to the initial rank). This process may then be repeated for all of the free parameters successively. Then, the parameter set may be updated for all parameters that had let to an improvement in rank, relative to how much the improvement was.

When thus updating the parameter set to determine the further set of parameters, it is important that only a fraction of a difference between the further set and the first set is used for determining the second set, since otherwise the system would become instable after a few learning steps.

To save time in busy periods of the recommendation system, it is possible to compute the gradient or rank improvement only with respect to a part of the free parameters, e.g. with respect to only or a few promising candidates.

In a further embodiment, it is possible that the further set of parameters is only determined after a predetermined number of successful recommendations and/or after a predetermined period of time. In this embodiment, the further set of parameters may be determined such that in a recommendation list output by the recommendation system based on the further set of parameters, an average rank of all successful recommendations is improved compared to a further average rank of all successful recommendations in a further recommendation list output by the recommendation system based on the first set of parameters.

Thus, the rank gradient computation and the parameter update may not be performed after any single purchase, but only after a bunch of purchases, e.g. every 32 purchases, or every hour or the like. In this case, the rank gradient is the average rank gradient overall the purchases in the bunch.

For avoiding any instability and further for avoiding that the recommendation system evolves towards an undesired behavior, getting stuck in a local extremum of the parameter space, this “Brownian motion like” selection of the second set of parameters may be combined with a step of comparing the behavior of the recommendation system based on the current parameter set occasionally with a previous set of parameters, such as the initial set of parameters A_{1, 1}, as will be discussed in the following.

In a corresponding embodiment, after a predetermined number of iterations of the method, the second set of parameters may be set, in the determining step, to a previous set of parameters, for example the first set or an intermediate set, e.g. a parameter set that has been evaluated as being successful in a previous testing and selecting step. This may allow recovering from an optimization towards a local extremum of the target function within the parameter space.

In a further embodiment of the method, the recommendation system may not just recommend a single item, but rather a list of several, e.g. three to five, items to a respective user. In such an embodiment, it is possible to mix items from different lists, as will be discussed in the following.

In a variation of such an embodiment, a recommendation output by the recommendation system using the first set of parameters may include a list of recommended items. To this list, a further item may be added, the further item being determined by the recommendation system using the second set of parameters or a set of parameters previously evaluated.

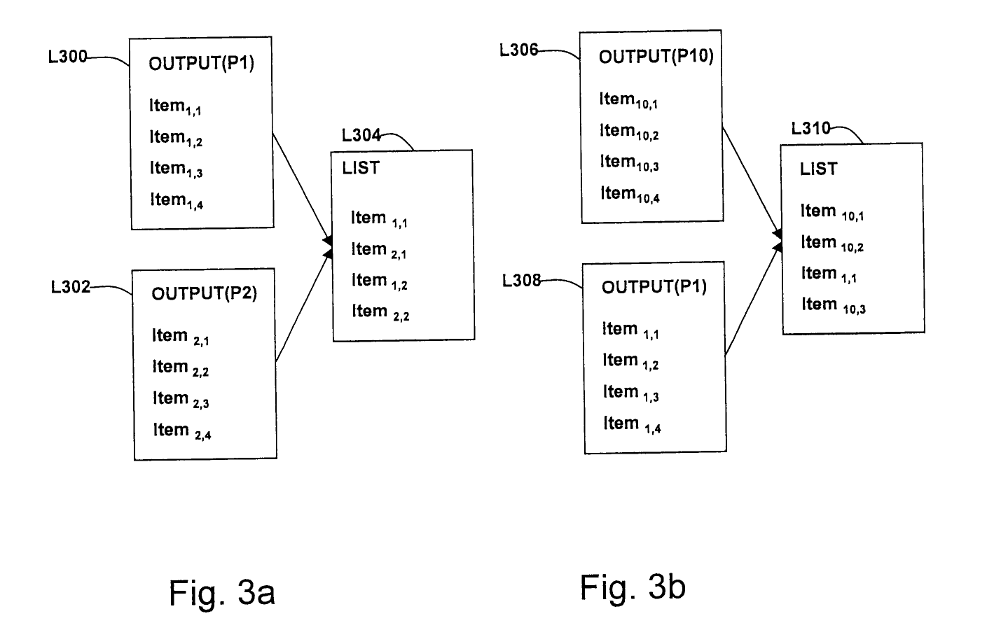

Such an intermixing is illustrated in FIGS. 3a and 3b. In FIG. 3a, a recommendation output from the recommendation system using a first set of parameters P1 is illustrated in a first list L300. Further, an output of the recommendation system using a second set of parameters P2 is illustrated in a second list L302. These lists may be combined before being output to a requesting user to a combined list L304 including items of both lists L300 and L302.

In FIG. 3b, an output list L306 obtained from the recommendation system using a current set of parameters P10 is shown to be intermixed with an early list of recommendations, e.g. issued by the recommendation system using an initial set of parameters P1.

With this embodiment, it may be assured that even one of the sets of parameters performs poorly, the lists L304 or L310 presented to the user may anyhow include some reasonable items.

As discussed in the above, at least some of the parameters included in at least one of the current set of parameters, the first set of parameters and the second set of parameters may depend on a user to whom the recommendations are output. For example, the parameters may be derived based on a personal profile of the user, describing the user's personal taste, and logging historical data with respect to the user's behavior.

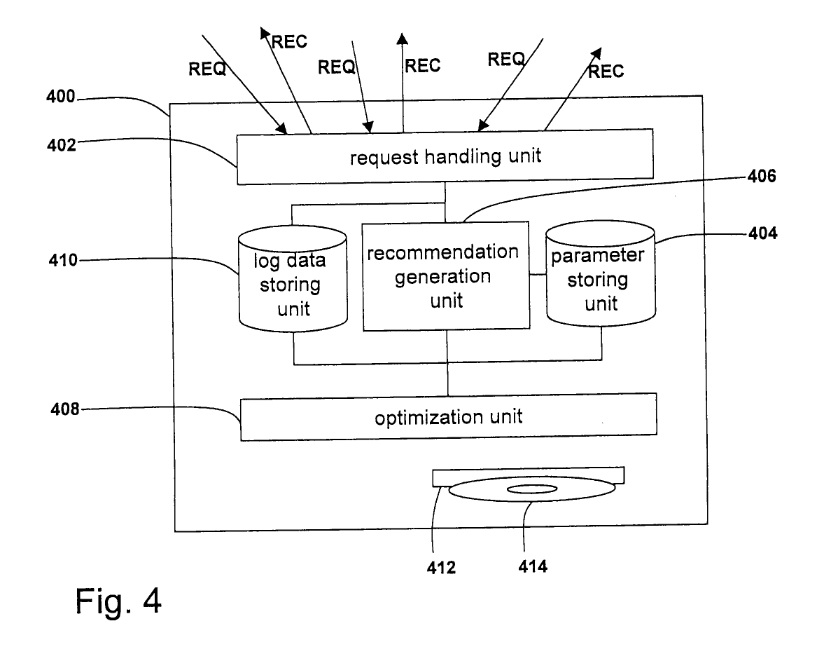

In FIG. 4, an embodiment of a recommendation system 400 is illustrated. As depicted, the recommendation system may include a request handling unit 402 adapted to receive recommendation requests and to output recommendations with respect to the received recommendation requests. Recommendation system 400 may further comprise a parameter storing unit 404 adapted to store at least one set of parameters. Further, recommendation system 400 may comprise a recommendation generation unit 406 adapted to determine, with respect to the requests received by request handling unit 402 and based on a set of parameters stored in parameter storing unit 404, recommendations to be output by request handling unit 402.

Further, an optimization unit 408 may be provided, which may be adapted to determine a first set of parameters depending on a current set of parameters stored in parameter storing unit 404 and a second set of parameters, e.g. depending on the first set of parameters and based on user actions with respect to previous recommendations, e.g. historical data, and to store the first set of parameters and the second set of parameters in the parameter storing unit. Further, optimization unit 408 may be adapted to cause recommendation generation unit 406 to select, according to a given random distribution, the first of parameters or the second set of parameters as a basis for determining a recommendation with respect to a given recommendation request. Further, optimization unit 408 may be adapted to compare, with respect to a predetermined target function, a success of the recommendations determined on the basis of the first set of parameters with a success of the recommendations determined on the basis of the second set of parameters. Still further, optimization unit 408 may be adapted to select and store, according to result of the comparison, the first set of parameters or the second set of parameters as the current set of parameters in parameter storing unit 404.

In a further embodiment, optimization unit 408 may be further adapted to iteratively optimize the current set of parameters stored in the parameter storing unit.

As mentioned in the above, the second set of parameters may be determined based on user actions with respect to previous recommendations. For example, information may be gathered and stored within the recommendation system, which information describes user actions with respect to recommendations issued by the recommendation system in the past. This information forms historical data upon which the second set of parameters may for example be determined.

It may for example be observed whether a user has selected and/or purchased an item recommended by the recommendation system. In this case, the recommendation may be marked as successful. Further, the information may indicate whether a user has selected an item recommended to him for obtaining further information with respect to the item. Still further, explicit feedback given by the user with respect to a recommended item may also be stored. The information is in the following also referred to as historical information, since reflecting user reactions to the recommendations observed in the past.

Consequently, the second set of parameters may depend on the first set of parameters and on user actions with respect to previous recommendations. These actions may for example be stored in a log data storing unit 410, e.g. by request handling unit 402, and may be accessed therefrom by optimization unit 408.

Further, recommendation system 400 may also include a reading unit 412 for reading computer-readable storage media e.g. including a computer program product, which, when executed by a processor, may cause the processor to execute any of the embodiments of the method as described herein. The computer program product may, for example, be stored on a storage medium 414.

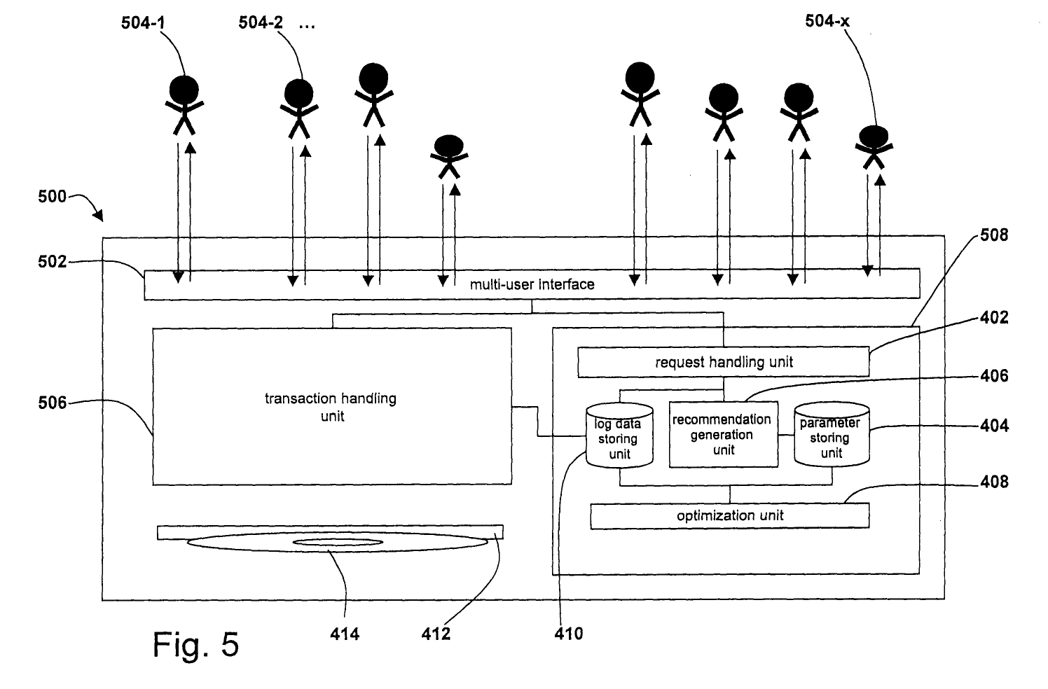

In FIG. 5, a purchasing system 500 including a multi-user interface 502 adapted to handle sessions of a plurality of users 504-1, 504-2, . . . , 504-x is illustrated. In the sessions, the users are supported by purchasing recommendations and conclude purchasing transactions. Purchasing system 500 further includes a transaction handling unit 506 adapted to process the purchasing transactions concluded in multi-user interface 502.

Further, a recommendation system 508 corresponding to the one illustrated in FIG. 4 is included. As discussed with respect to FIG. 4, recommendation system 508 may include a request handling unit 402, a parameter storing unit 404, a recommendation generation unit 406, an optimization unit 408 and a log data storing unit 410. Requesting handling unit 402 receives the recommendation requests issued by the users 504-1 to 504-x from multi-user interface 502, and outputs recommendations via multi-user interface 502 to the users 504-1 to 504-x in response to the requests as the purchasing recommendations.

A success of a respective recommendation is determined depending on whether a purchasing transaction is concluded in multi-user interface 502 based on the respective recommendation. This may be determined, for example, by transaction handling unit 506, and may be stored in log data storing unit 410. The historical data including information on behavior of users 504-1 to 504-x in the past is thus stored in log data storing unit 410 and may be used as a basis for optimization, for example as a basis for determining the second set of parameters based on the first set of parameters as discussed in the above.

Thus, in accordance with the above, a deployed recommendation system, e.g. recommendation system 400 or recommendation system 508, may be automatically and dynamically optimized with respect to its parameters, thereby adapting to changing conditions automatically. The optimization may thus be adapted to find a near optimal operation point over time, in particular when working conditions do not change or change slowly.

The approach combines optimization based on an evaluation of historical data with a testing approach under live conditions for multiple sets of parameters. It thus allows to firstly base optimization on the data observed by the recommendation system, but to also include further aspects, e.g. by amending the parameters, which may help to evolve the system with respect to new conditions, and which may further help to allow unexpected “serendipity” recommendations.

Further, since new sets of parameters may be tested under “life” conditions, a risk of the parameter set performing poorly when deployed is avoided or at least minimized.

Thus, advantages of optimization based on historical data and optimization using a testing approach under live conditions are combined.

Further, measures for assuring that at least some of the recommendations may be helpful to the users and for preventing the optimization of getting stuck at local extrema within the parameter space are discussed.

The evolution of the recommending system is further assessed under realistic conditions, and thus directly measurable with respect to a predefinable target function. Thus, the optimization approach may be applied with respect to various optimization targets.

1. Method for optimizing a current set of parameters in a recommendation system during runtime, including
a determining step for determining a first set of parameters depending on the current set of parameters and a second set of parameters depending on the first set of parameters and on user actions with respect to previous recommendations;
a testing step for comparing, during runtime and with respect to a predetermined target function, an output of the recommendation system using the first set of parameters against an output of the recommendation system using the second set of parameters; and
a selecting step for selecting the first set of parameters or second set of parameters as the current set of parameters depending on a comparison result of the testing step.

2. Method according to claim 1, wherein
after having concluded the selecting step, the determining step, the testing step and the selecting step are repeated.

3. Method according to claim 1, wherein
the target function depends on a proportion of successful recommendations with respect to all recommendations output by the recommendation system.

4. Method according to claim 1, wherein
in the determining step, the second set of parameters is determined depending on the first set of parameters by modifying at least one of the parameters of the first set of parameters.

5. Method according to claim 1, wherein
the modifying of the at least one of the parameters is based on a random variation of the at least one of the parameters.

6. Method according to claim 1, wherein
in the determining step, a gradient of the target function is determined with respect to the first set of parameters, and the second set of parameters is determined based on the gradient.

7. Method according to claim 1, wherein
a component of the gradient is estimated by determining an intermediate set of parameters based on the first set of parameters by modifying a respective one of the parameters of the first set of parameters, and by evaluating, during runtime and with respect to the target function, the output of the recommendation system using the first set of parameters and the output of the recommendation system using the intermediate set of parameters.

8. Method according to claim 1, wherein
after a successful recommendation during runtime, the determining step, the testing step and the selecting step are carried out, and wherein
in the determining step, the current set of parameters is used as the first set of parameters, a further set of parameters is determined based on the first set of parameters by varying at least one of the parameters of the first set such that in a recommendation list output by the recommendation system based on the further set of parameters, a rank of the successful recommendation is improved compared to a further rank of the successful recommendation in a further recommendation list output by the recommendation system based on the first set of parameters, and the second set of parameters is determined based on a fraction of a difference between the further set and the first set.

9. Method according to claim 8, wherein
the further set of parameters is only determined after a predetermined number of successful recommendations and/or after a predetermined period of time, and wherein
the further set of parameters is determined such that in a recommendation list output by the recommendation system based on the further set of parameters, an average rank of all successful recommendations is improved compared to a further average rank of all successful recommendations in a further recommendation list output by the recommendation system based on the first set of parameters.

10. Method according to claim 1, wherein
after a predetermined number of iterations of the method, the second set of parameters is set, in the determining step, to a previous set of parameters for recovering from an optimization towards a local extremum of the target function.

11. Method according to claim 1, wherein
a recommendation output by the recommendation system using the first set of parameters includes a list of recommended items, and wherein
to the list, a further item is added, the further item being determined by the recommendation system using the second set of parameters or a set of parameters previously used.

12. Method according to claim 1, wherein
at least some of the parameters included in at least one of the current set of parameters, the first set of parameters and the second set of parameters depend upon a user to whom recommendations are output.

13. Computer program, which, when executed by a processor, causes the processor to execute the method of any of the preceding claims.

14. Recommendation System, including
a request handling unit adapted to receive recommendation requests and to output recommendations with respect to the received recommendation requests;
a parameter storing unit adapted to store at least one set of parameters;
a recommendation generation unit adapted to determine, with respect to the requests received by the request handling unit and based on a set of parameters stored in the parameter storing unit, recommendations to be output by the request handling unit;
an optimization unit adapted to
determine a first set of parameters depending on a current set of parameters stored in the parameter storing unit and a second set of parameters depending on the first set of parameters and on user actions with respect to previous recommendations, and to store the first set of parameters and the second set of parameters in the parameter storing unit, further adapted to
cause the recommendation generation unit to select, according to a given random distribution, the first set of parameters or the second set of parameters as a basis for determining a recommendation with respect to a given recommendation request, further adapted to
compare, with respect to a predetermined target function, a success of the recommendations determined on the basis of the first set of parameters with a success of the recommendations determined on the basis of the second set of parameters, and further adapted to
select and store, according to a result of the comparison, the first set of parameters or the second set of parameters as the current set of parameters in the parameter storing unit.

15. Recommendation system according to claim 14, wherein
the optimization unit is adapted to iteratively optimize the current set of parameters stored in the parameter storing unit.

16. Purchasing system, including
a multi-user interface unit adapted to handle sessions of a plurality of users, wherein in the sessions, the users are supported by purchasing recommendations and conclude purchasing transactions;
a transaction handling unit adapted to process the purchasing transactions concluded in the multi-user interface unit; and
a recommendation system according to claim 14, wherein the request handling unit receives the recommendation requests from the multi-user interface and outputs the recommendations as the purchasing recommendations to the multi-user interface, and wherein the success of a respective recommendation is determined depending on whether a purchasing transaction is concluded in the multi-user interface based on the respective recommendation.
